(19) United States
(12) Patent Application Publication
(10) Pub. No.: US 2012/0103124 A1
(43) Pub. Date: May 3, 2012

(54) DELTA ROBOT

(75) Inventors: Justus Laurens Herder, Den Haag (NL); Volkert Van Der Wijk, Benschop (NL)

(73) Assignee: Technische Universiteit Delft, Delft (NL)

(21) Appl. No.: 13/291,011

(22) Filed: Nov. 7, 2011

Related U.S. Application Data
(63) Continuation of application No. PCT/NL2010/050253, filed on May 3, 2010.

(30) Foreign Application Priority Data
May 5, 2009 (NL) 2002839

(51) Int. Cl. B25J 18/00

(52) U.S. Cl. 74/490.01; 901/48

(57) ABSTRACT

A delta robot comprising a stationary base and a movable platform that is connected to the base with three chains of links, and comprising a balancing system incorporating at least one pantograph for balancing the robot's center of mass, wherein the at least one pantograph has a first free extremity at which it supports a countermass which is arranged to balance the center of mass of the robot.

### CROSS-REFERENCE TO RELATED APPLICATIONS

This application is a continuation application of International Patent Application Serial No. PCT/NL2010/050253, entitled “Delta Robot”, filed on May 3, 2010, which is a continuation of Netherlands Patent Application Serial No. 2002839, entitled “Delta Robot”, filed on May 5, 2009, and the specification and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

1. Field of the Invention (Technical Field):

The present invention relates to a delta robot comprising a stationary base and a movable platform that is connected to the base with three legs or—as they are also called—chains of links, and comprising a balancing system incorporating at least one pantograph for balancing the robot's center of mass.

2. Description of Related Art:

FR-A-2 880 575 teaches a delta robot comprising a stationary base and a movable platform that is connected to the base with tree chains of links, and comprising a balancing system incorporation a pantograph, wherein the pantograph has a first free extremity at which it supports a countermass.

Further a statically balanced delta robot is known from the article “Design and prototyping of a new balancing mechanism for spatial parallel manipulators” by C. Baradat et al., published in the ‘Journal of Mechanical Design’, July 2008, Vol. 130/072305—1-13. In this article it is mentioned that the delta robot was developed for high speed manipulation and that it is well-known in the electronics, food and pharmaceutical sectors as a reliable system with fast execution of light-duty tasks. However, in recent years much attention has been paid to a number of possible industrial applications, such as the manipulation of medical devices.

The said article provides a comprehensive overview of methods for statically balancing robot mechanisms for which purpose different balancing schemes can be applied, notably by using counterweights, by applying springs or by applying pneumatic or hydraulic cylinders, electromagnetic devices, etc.

The article focuses on a particular solution for the balancing of the robot incorporating for this purpose at least one pantograph that is mounted on a rotating stand that is connected with the base. At a position distant from the point where the pantograph mechanism is mounted to the rotating stand, the pantograph is connected to the moveable platform. Furthermore, the delta robot as suggested in the said article employs an actuator that produces a vertical force that is used for balancing the gravitational forces of the robot.

### BRIEF SUMMARY OF THE INVENTION

It is an object of the invention to provide a delta robot according to the preamble which is devoid of any active system embodied as actuators as proposed by said article, yet allows that the robot will be able to move rapidly and accurately and have a range of motion which answers to the needs as they may arise in the above-mentioned applications.

As a general objective of the invention it is intended to provide an alternative to existing solutions for balancing the robot in a manner that the reaction forces that occur during operation of the delta robot are effectively avoided. Such a robot is not only statically balanced but also force-balanced. A further objective is that vibrations that would result from imbalances in the construction of the robot, are prevented, which vibrations might otherwise deteriorate the operational accuracy of the delta robot. The avoidance of vibrations also results in less noise, and reduced wear.

### BRIEF DESCRIPTION OF THE SEVERAL VIEWS OF THE DRAWINGS

The invention hereinafter will be further elucidated with reference to the drawing of several embodiments of the delta robot of the invention.

In the drawing:

FIG. 1 shows a first embodiment of the delta robot of the invention;

FIG. 2 shows a second embodiment of the delta robot of the invention;

FIG. 3 shows a third embodiment of the delta robot of the invention,

FIG. 4 shows a fourth embodiment of the delta robot of the invention, and

FIG. 5 shows the fifth embodiment of the delta robot of the invention forming a variation to the fourth embodiment shown in FIG. 4.

Wherever in the figures the same reference numerals are applied, these numerals refer to the same parts.

### DETAILED DESCRIPTION OF THE INVENTION

It is expressly remarked that wherever in the description mention is made to the moveable platform, this platform is deemed to include the situation that the platform supports an instrument. The mass of the instrument is then deemed concentrated in the mass of the said platform. Further it is remarked that wherever in the description mention is made of balancing a particular item, this should be understood as providing an equilibrium to such item. Consequently wherever the word “balancing” occurs in the description, this word can be replaced by “providing an equilibrium to” and vice versa. The same applies to the verb “to balance” which can be replaced by “to provide equilibrium to” and vice versa.

From the article “Design and Prototyping of a New Balancing Mechanism for Spatial Parallel Manipulators” by C. Baradat, et al., published in the ‘Journal of Mechanical Design’, July 2008, Vol. 130/072305—1-13, the preamble of the independent claims 1 and 3 is known, notably that the at least on pantograph has a first free extremity at which is supports a countermass which is arranged to balance the center of mass of the robot.

The objectives of the invention are entirely or in part achieved with a delta robot that in accordance with the invention is characterized by one or more of the appended claims.

The invention is based on the insight that the dynamic reaction forces that occur during operation of the delta robot will be zero if the center of mass of the robot is made stationary for any motion of robot mechanism.

A first possible embodiment of the delta robot of the invention has the features that the at least on pantograph has a second extremity distant from the first extremity, which second extremity is connected at a preselected position with connectors to the respective legs or chains of link connecting the platform with the base, whereby said position of the second extremity is arranged to coincide with the original center of mass of the robot. The “original center of mass” herein refers to the center of mass of the moving elements of the robot before balancing.

A simpler and therefore more preferred embodiment that embodies the invention has the features that the three lins that connect to the base are individually balanced with countermasses positioned at arms extending from said links beyond hinges for coupling said links to the base, and that the at least one pantograph has a second extremity distant from the first extremity, which second extremity distant from the first extremity, which second extremity connects to the platform so as to balance said platform and at least part of the chains of links connecting said platform to the base.

A further preferred embodiment of the delta robot of the invention has the features that it is provided with three pantographs each pantograph being partly coinciding with one of the three chains of links and each one of the three chains of links partly coinciding with one of the pantographs such that for each of the chains of links and for each corresponding pantograph there is an arm of the pantograph that extends parallel to a link of the chains of legs connecting to the base, wherein said arm supports a countermass and wherein each countermass is positioned to balance its chain of links and a one third part of the platform. This embodiment is preferred in view of its symmetrical design characteristics which makes it easy to employ with a particular delta robot.

In terms of the number of parts to be employed being very limited the delta robot of the invention is preferably arranged such that part of the at least one pantograph is a first link of a first chain of links, whereby the first link connects to the base, and that the said first free extremity of the pantograph supporting the countermass is provided on a first arm of the pantograph which runs parallel to said first link, whereby said first arm connects with a hinge distant from the countermass to a second arm of the pantograph, which second arm is arranged as an extension of a second link of said first chain of links, which second link connects to the platform, and wherein the countermass balances at least part of the platform, and at least part of the legs or chains of links connecting the platform to the base.

In this construction of the delta robot there again is only one pantograph needed for supporting a countermass.

Preferably, the latter two embodiments of the delta robot according to the invention can be further characterized in that same is provided with two further countermasses, to balance at least part of a second and a third chain of links. As already mentioned it is possible that the two further countermasses as just mentioned are supported by two further pantographs in order to realize the above-mentioned embodiment having the symmetrical construction.

To simplify the design it may however be preferable that each of the two further countermasses is individually provided on a supporting arm which is arranged as an extension beyond a hinge of the link forming part of the second or third chain of links that connects at said hinge to the base.

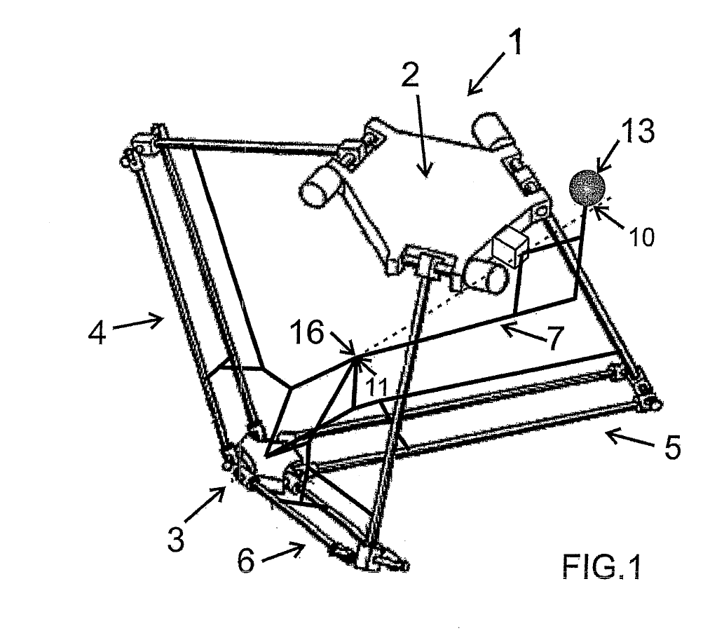

Throughout the FIGS. 1-5 reference numeral 1 is applied to refer to the integral delta robot of the invention. This delta robot 1 comprises a stationary base 2 and a moveable platform 3. The moveable platform 3 may or may not be embodied with a further device, whereby said device may be manipulated with the delta robot 1 into a desired position. The platform 3 as shown in the figures is deemed to include such a device. At least the mass of such a device is deemed comprised in the mass of the platform 3 for the purpose of the following elucidation.

The platform 3 is connected to the base 2 with three legs or chains of links 4, 5 and 6 and comprises a balancing system incorporating at least one pantograph 7, 8, 9 for force—balancing the centre of mass of the delta robot 1.

With reference now in particular to FIG. 1, a first embodiment is shown in which the applied pantograph 7 has a first free extremity 10 at which it supports a countermass 13 which is arranged to balance the center of mass 16 of the robot. For this purpose the pantograph 7 has a second extremity 11, which is distant from the first extremity 10 and at which second extremity 11 the pantograph 7 is connected with connectors (as the figure clearly shows) to the respective chains of links 4, 5, 6 connecting the platform 3 with the base 2. The position of the second extremity 11 is arranged to coincide with the original center of mass 16 of the robot 1, which is the center of mass before providing the balancing mechanism.

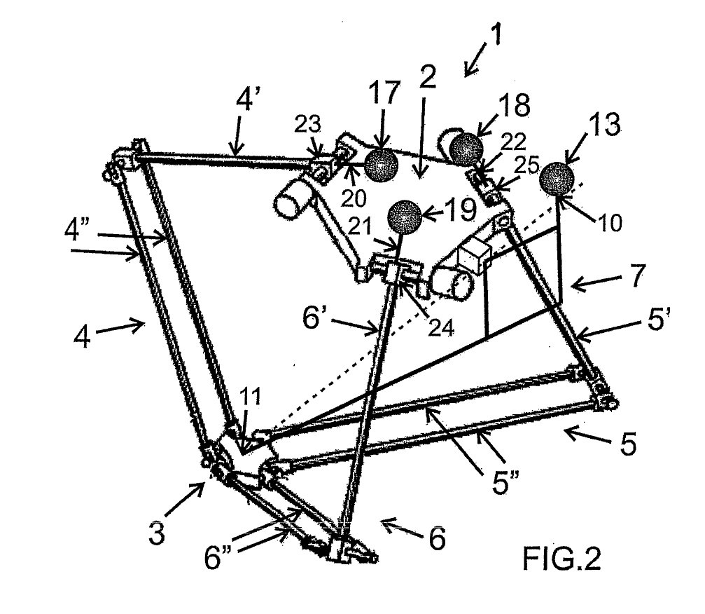

A second embodiment is shown in FIG. 2 in which the three links 4′, 5′ and 6′ that connect to the base 2 and part of the mass of the three links 4″, 5′″, 6″ connecting to the platform 3, are individually balanced with countermasses 17, 18, 19. These countermasses 17, 18, 19 are positioned at arms 20, 21, 22 that extend from said links 4′, 5′, 6′ beyond hinges 23, 24, 25 that are applied for coupling the links 4′, 5′, 6′ to the base 2.

Further, FIG. 2 shows that the pantograph 7 again has a second extremity 11 which is distant from the first extremity 10 that supports the countermass 13, and which second extremity 11 connects to the platform 3 so as to balance the platform and the yet unbalanced part of the legs 4, 5, 6 (i.e. a part of the claims of links 4, 5, 6) that connect the platform 3 to the base 2.

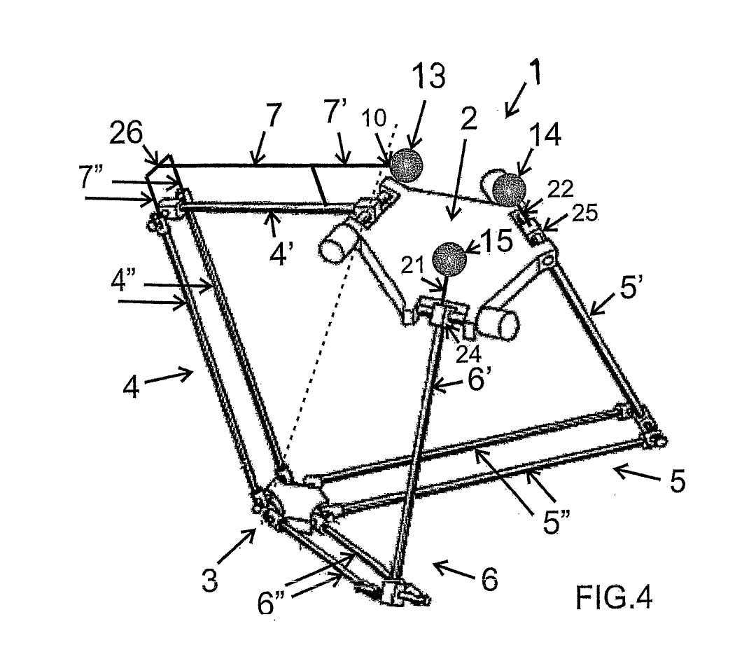

Making further reference to FIG. 4 an embodiment is shown in which part of the pantograph 7 is a first link 4′ of a first chain of links 4 whereby the first link 4′ connects to the base 2. The first free extremity 10 of the pantograph 7 supporting the countermass 13 is provided on a first arm 7′ of the pantograph 7, which runs parallel to the first link 4′, and this first arm 7′ connects with a hinge 26 distant from the countermass 13 to a second arm 7″ of the pantograph 7. This second arm 7″ of the pantograph 7 is thereby arranged as an extension of a second link 4″ of the first chain of links 4, whereby the second link 4″ connects to the platform 3. In this construction the countermass 13 balances the complete leg or chain of links 4 connecting the platform 3 to the base 2, the platform 3 and part of the links 5″ and 6″ connected to the platform 3. Furthermore, this embodiment is provided with two further countermasses 14, 15, which are intended to balance at least part of the second and third chain of links 5, 6 notably to balance the links 5′, 6′ and part of the links 5″, 6″.

As FIG. 4 clearly shows, each of the two further countermasses 14, 15 is individually provided on a supporting arm 21, 22, which is arranged as an extension beyond a hinge 24, 25 of the link 5′, 6′ forming part of the second or third chain of links 5, 6 that connects at said hinge 24, 25 to the base 2.

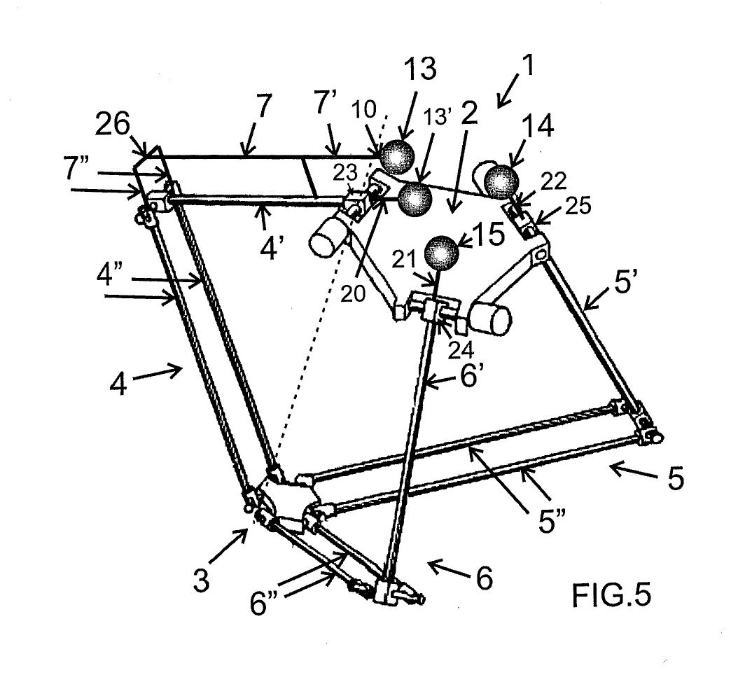

FIG. 5 shows a variation to the embodiment shown in FIG. 4 in that it has a further countermass 13′ which is provided on a supporting arm 20 which is arranged as an extension beyond a hinge 23 of the link 4′ forming part of the first chain of links 4 that connects at said hinge 23 to the base 2. In this embodiment the mass of countermass 13 can be advantageously reduced as compared to the mass of countermass 13 as applied in the embodiment shown in FIG. 4.

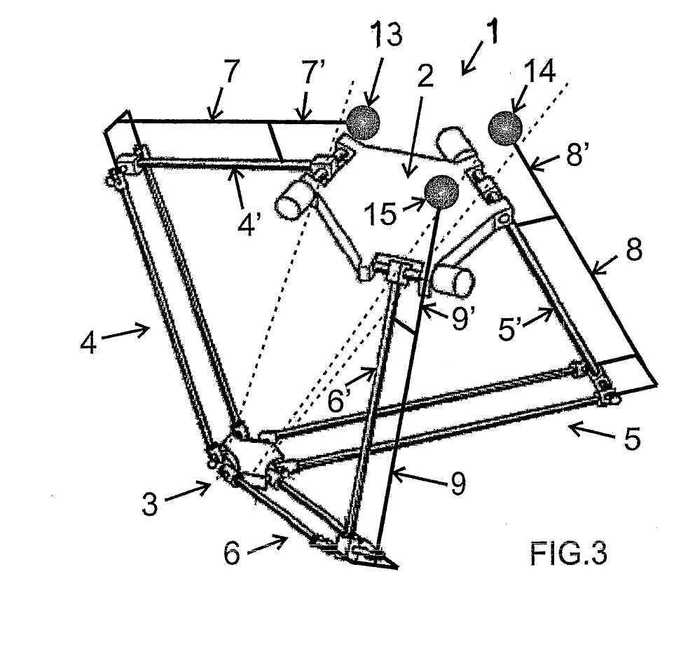

Finally, with reference to FIG. 3 an embodiment is shown of the delta robot 1 of the invention, which is provided with three pantographs 7, 8, 9, wherein each pantograph 7, 8, 9 is partly coinciding with one of the three chains of links 4, 5, 6 and each one of the three chains of links 4, 5, 6 is partly coinciding with one of the said pantographs 7, 8, 9. This is embodied in a manner that for each of the chains of links 4, 5, 6 and for each corresponding pantograph 7, 8, 9 there is an arm 7′, 8′, 9′ of the pantograph 7, 8, 9 that extends parallel to a link 4′, 5′, 6′ of the chains of links 4, 5, 6 connecting to the base 2.

Each of said arms 7′, 8′, 9′ thereby supports a countermass 13, 14, 15, whereby each countermass 13, 14, 15 is positioned to balance its chain of links 4, 5, 6 and a one third part of the platform 3.

What is claimed:

1. Delta robot comprising a stationary base and a movable platform that is connected to the base with three chains of links and comprising a balancing system incorporating at least one pantograph for providing an equilibrium to the robot's center of mass,
wherein the at least one pantograph has a first free extremity at which it supports a countermass which is arranged to balance so as to provide an equilibrium to the center of mass of the robot,
wherein the at least one pantograph has a second extremity connected at a preselected position with connectors to the respective chains of links connecting the platform with the base, whereby said position is arranged to coincide with the original center of mass of the robot.

2. Delta robot according to claim 1, wherein the three links that connect to the base are individually balanced with countermasses positioned at arms extending from said links beyond hinges for coupling said links to the base, and wherein at least one pantograph has a second extremity distant from the first extremity, which second extremity connects to the platform so as to balance for providing an equilibrium to said platform and at least part of the chains of links connecting the platform with the base.

3. Delta robot comprising a stationary base and a movable platform that is connected to the base with three chains of links and comprising a balancing system incorporating at least one pantograph for providing an equilibrium to the robot's center of mass,
wherein the at least one pantograph has a first free extremity at which it supports a countermass which is arranged to balance so as to provide an equilibrium to the center of mass of the robot,
wherein part of the at least one pantograph is a first link of the first leg or chain of links,
whereby the first link connects to the base and wherein said first free extremity of the pantograph supporting countermass is provided on a first arm of the pantograph which runs parallel to said first link,
whereby said first arm connects with a hinge distant from the countermass to a second arm of the pantograph, which second arm is arranged as an extension of a second link of said first chain of links, which second link connects to the platform, and
wherein the countermass balances at least part of the platform and at least part of the legs connecting the platform to the base.

4. Delta robot according to claim 3, wherein same is provided with two further countermasses to balance at least part of a second and third chain of links.

5. Delta robot according to claim 4 wherein each of the two further countermasses is individually provided on a supporting arm which is arranged as an extension beyond a hinge of the link forming part of the second or third chain of links that connects at said hinge to the base.

6. Delta robot according to claim 3, wherein same has a further countermass which is provided on a supporting arm which is arranged as an extension beyond a hinge of the link forming part of the first chain of links that connects at said hinge to the base.

7. Delta robot according to claim 3, wherein same is provided with three pantographs, each pantograph being partly coinciding with one of the three chains of links and each one of the three chains of links partly coinciding with one of the pantographs such that for each of the chains of links and for each corresponding pantograph there is an arm of the pantograph that extends parallel to a link of the chains of links connecting to the base, wherein said arm supports a countermass and wherein each countermass is positioned to balance its chain of links and a one third part of the platform.
